(19) United States
(12) Patent Application Publication
(10) Pub. No.: US 2008/0280265 A1
(43) Pub. Date: Nov. 13, 2008

(54) MOBILITY MAP AND SYSTEM

(76) Inventor: Eric Lopez-Jaime, Naguabo, PR (US)

Correspondence Address: ROBERTO J. RIOS, 256 ELEANOR ROOSVELT, SAN JUAN, PR, 00918, US

(21) Appl. No.: 12/113,215

(22) Filed: May 1, 2008

Related U.S. Application Data
(60) Provisional application No. 60/915,153, filed on May 1, 2007.

(51) Int. Cl. G09B 21/00

(52) U.S. Cl. 434/112

(57) ABSTRACT

The system is a universal code whose main purpose is to provide visually impaired people with much wanted personal independence. A mobility map of the invention comprises a series of embossed/engraved symbols and/or other raised pictographs combining Braille code and other alphanumeric symbols. This symbols are exposed atop of a surface, and will be composed of two different panels combined together to form a mobility map or plan. A multi-level hierarchy mobility system is also provided to allow visually-impaired individuals to move freely and relocate not only within a structure such as a building but also within many geographical levels such as states, cities, and neighborhoods without losing the structural and/or spatial relationship among the different levels.

### FIELD OF THE INVENTION

This invention relates to a system that will allow visually impaired people to geographically move among locations. More specifically, this invention relates to a system that will allow visually impaired people to move within a country, a city, a ward, a street and/or a structure.

### BACKGROUND OF THE INVENTION

For people with normal sight, moving through a building, a park or a city is somehow a triviality, however for visually impaired individuals, moving inside a room or roaming through a public space may be a daily challenge. Generally, when faced with learning how to move in a new setting an individual will rely on maps that contain a visual representation of the locations of areas of interest. There are however, instances where the individual is not able to refer to the visual cues in the environment and recalling information previously provided on navigational charts. This could be the result of visual impairment of the individual or of some other handicap that keeps the individual from being able to refer to either a navigational chart or to the location cues. For example, an emergency worker carrying equipment such as heavy masks that hinders him/her from efficiently interpreting a map or in need to navigate in unfamiliar areas and be unable to simultaneously locate their position on a map.

A major problem for the visually impaired community is independent navigation. The visually impaired people must rely on others to learn their way around a new setting, which reduces their sense of independence. There is a need for a device to help such individuals to navigate or learn new routes. Various techniques have been developed in an attempt to meet these needs. All provide partial navigation support but fail to provide complete indoors and out of doors navigation support, and setting going from a micro-area (e.g. a building) to a macro-area (e.g. a city). There is also the need to provide visually impaired people with a rapidly decipherable system so as to assist them with escaping routes during emergencies such as natural disasters, fires and terrorist attacks.

### SUMMARY OF THE INVENTION

The system is a universal code whose main purpose is to provide visually impaired people with much wanted personal independence. The system is based on a series of embossed symbols and/or other raised pictographs combining Braille code and other alphanumeric symbols. This symbology will be exposed atop of a polymeric surface, and will be composed of two different panels combined together to form a navigational chart, as will be extensively explained on the detailed description of the invention.

Visually impaired people, using the system of the invention; will be able to navigate inside a building, parks, sidewalks, and mass transportation systems like trains, ships, buses and airplanes. Also, visually impaired people will be able to easily navigate inside malls, tourist attractions, etc; as the polymeric surface with the embossed symbols and other raised pictographs will be placed on any needed location.

According to one aspect of the invention, the symbols and/or pictographs symbols are also combined with an electronic means synchronized with portable means such as but not limited to: pagers, whose main purpose will be to provide visually impaired people with means to locate the navigational system of the invention. The communication between the electronic means and pager will provide the visually impaired person the exact location of the navigational chart by means of sound or vibration, so that the individual can read the chart with his or her hands.

In another aspect of the invention, a technological medium is used (code belt). The aforementioned medium will be located inside the visually impaired person's cane. The electronic belt is about the diameter of the cane and will communicate with the micro-chip integrated within the navigational chart of the invention. The electronic belt will have a small speaker, so as to provide the person with an audio signal when nigh to the chart.

In yet another aspect of the invention, combined with the embossed symbols and other raised pictographs chart is the Braille translator. The purpose of the aforementioned translator is to read the Braille code to a non-Braille literate user. In one embodiment, the system is composed of a small glove that covers at least two fingers and through a sensor exclusively codified to read Braille. The user will be able to read and understand Braille by means of tactile manipulation and ad-hoc networking—such as but not limited to Bluetooth.

The code or system according to the invention will facilitate the visual impaired person with a safe escape routes in case of emergencies and the ability to evacuate a structure in case of fires, natural disasters or terrorist attacks. The navigational system will allow the visually impaired person to know the exact location of exits, number of steps on stairs, extinguishers, fire alarms, among other important information.

The system of the invention will be financially wise advisable to the private and public sectors, as will spare them of possible lawsuits based on non-providing adequate signaling and access to handicapped individuals.

The system of the invention will be a standardized unique system that will be universally understood by visually impaired people.

### BRIEF DESCRIPTION OF THE DRAWINGS

Further features and advantages of the invention will become apparent from the following detailed description taken in conjunction with the accompany figure showing illustrative embodiments of the invention, in which:

FIG. 1A shows a graphical representation of a mobility map according to a preferred embodiment of the invention.

FIG. 1B shows a top view of a mobility map according to a preferred embodiment of the invention.

FIG. 2A shows a graphical representation of a mobility map legend with symbols and pictographs according to the system of the invention.

FIG. 2B shows a top view of a mobility map legend with symbols and pictographs according to the system of the invention.

FIG. 3A shows a graphical representation of another mobility map legend with symbols and pictographs according to the system of the invention.

FIG. 3B shows a top view of another mobility map legend with symbols and pictographs according to the system of the invention.

FIG. 4A shows a graphical representation of another mobility map legend with symbols and pictographs according to the system of the invention.

FIG. 4B shows a top view of another mobility map legend with symbols and pictographs according to the system of the invention.

FIG. 5 shows a graphical representation of a multi-level mobility map system according to a preferred embodiment of the invention.

FIG. 6 shows the mobility map system implemented in an environment according to an embodiment of the invention.

FIG. 7 shows the mobility map system implemented in another environment according to an embodiment of the invention.

FIG. 8 shows the mobility map system implemented in yet another environment according to an embodiment of the invention.

FIG. 9 shows the mobility map system implemented in a different environment according to an embodiment of the invention.

FIG. 10 shows a mobility map locating system according to one embodiment of the invention.

FIG. 11 shows a mobility map locating system according to another embodiment of the invention.

FIG. 12 shows a mobility map translating system according to an embodiment of the invention.

Throughout the figure, the same reference numbers and characters, unless otherwise stated, are used to denote like elements, components, portions or features of the illustrated embodiment. The subject invention will be described in detail in conjunction with the accompany figure, in view of the illustrative embodiment.

### DETAILED DESCRIPTION OF THE INVENTION

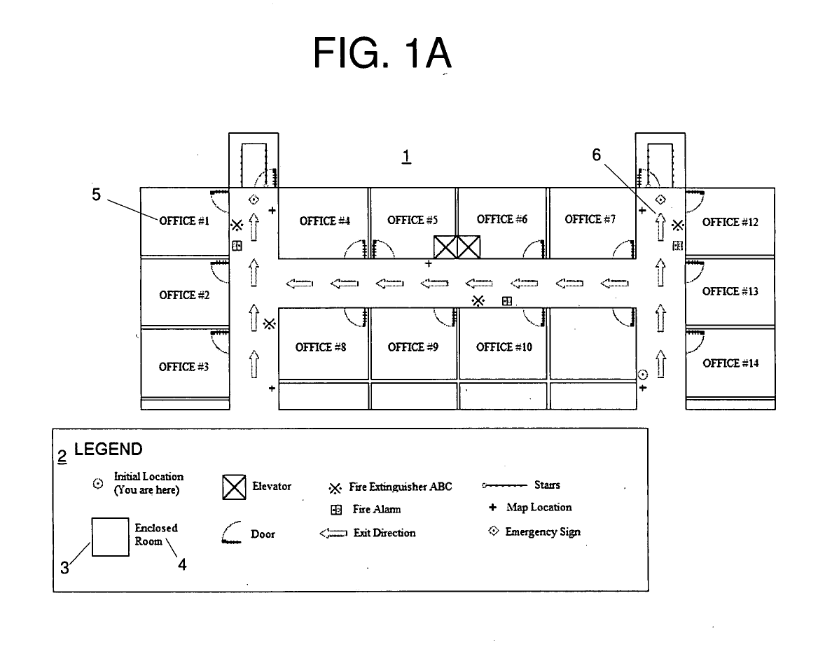

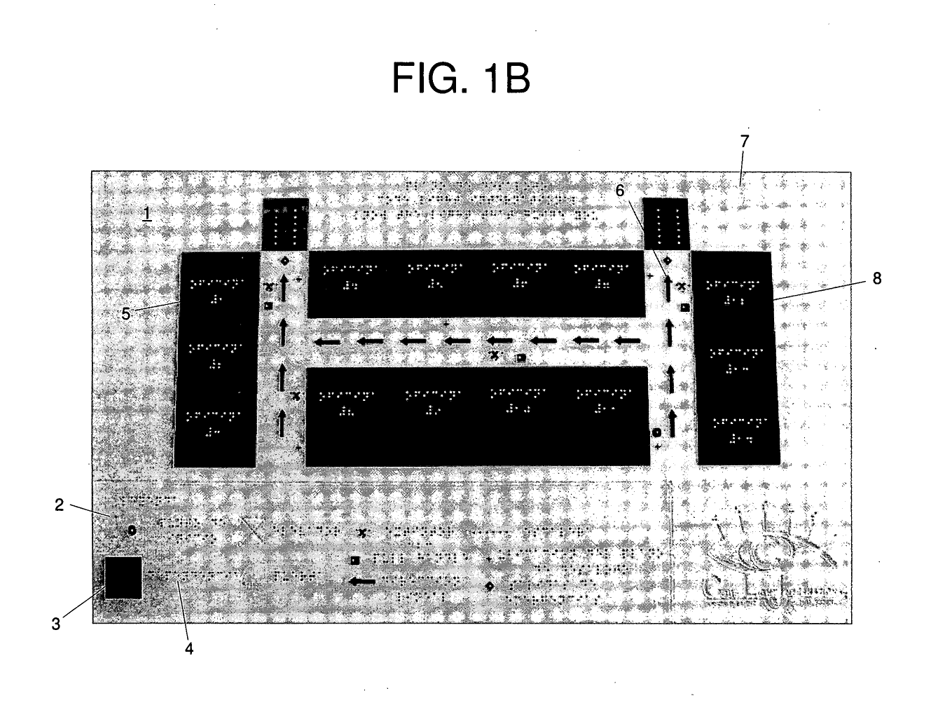

With reference to FIG. 1A, a graphical representation of mobility map 1 in accordance with an exemplary embodiment of the invention includes a floor plan layout of building structure. A legend 2 is provided where each element or graphical symbol 3 shown in the mobility map 1 is provided with a particular definition 4. Graphical symbols and/or pictographs 6 are selectively positioned in said mobility map 1 to clearly indicate a person the spatial relationship among elements encountered in a building structure. The floor plan of FIG. 1 illustrates the location of for example, individual rooms or offices, doors, stairs, elevators, fire extinguishers, and fire alarms in relation to said building structure. The mobility map 1 is also provided with information indicia 5 to visually identify several locations within said floor. In an embodiment of the invention, the information indicia 5 comprise alphanumeric characters such as text. In another embodiment of the invention, the information indicia 5 comprise visually-impaired code such as but not limited to Braille code. In a preferred embodiment of the invention, the information indicia 5 comprise a combination of alphanumeric characters and Braille code.

The mobility map 1 can be designed in a two-level arrangement as shown in FIG. 1B. According to a preferred embodiment of the invention, the two-level arrangement is defined by a first level 7 and a second level 8 positioned above said first level 7. In a preferred embodiment, the first level 7 comprises a rectangular plastic panel. However, other materials and shapes can also be used as long as proper positioning and identification of the graphical symbols and/or information indicia are ensured. The spatial representation of an area defined by the mobility map 1 such as a building floor is defined and at least partially represented in the first level 7 by engraved and/or embossed elements. At least some information indicia 5 such as Braille code can be embossed on said first level 7 and at least some tactile indicia 3 can be engraved in said first level 7 as shown in FIG. 1B. As used throughout the specification, information indicia are any symbol, code and/or representation used to convey alphanumeric information such as text to visually-impaired individuals. In contrast, tactile indicia as used throughout the specification are symbols and/or representations used to define any structural and/or spatial relationship between a defined area such as a building floor and an individual through touch. Once a first portion of spatial representation is defined on said first level 7, a second portion of the spatial representation is further defined on said second level 8. According to the exemplary embodiment shown in FIG. 1B, the second level 8 is used to define delimiting structural element such as walls, offices, doors, stairs, elevators and elements such as fire extinguishers, fire alarms, directional arrows and emergency exits. It can be seen that additional structural representations such as hallways can be provided by selectively positioning the second level 8 on top of said first level 7. In a preferred embodiment of the invention, the first level 7 comprises one base color such as but not limited to white and the second level 8 comprises a different contrasting color such as but not limited to red. This color arrangement functionally cooperates with the two-level panel arrangement to provide sighted and visually-impaired individuals with a means to identify and move within a defined area.

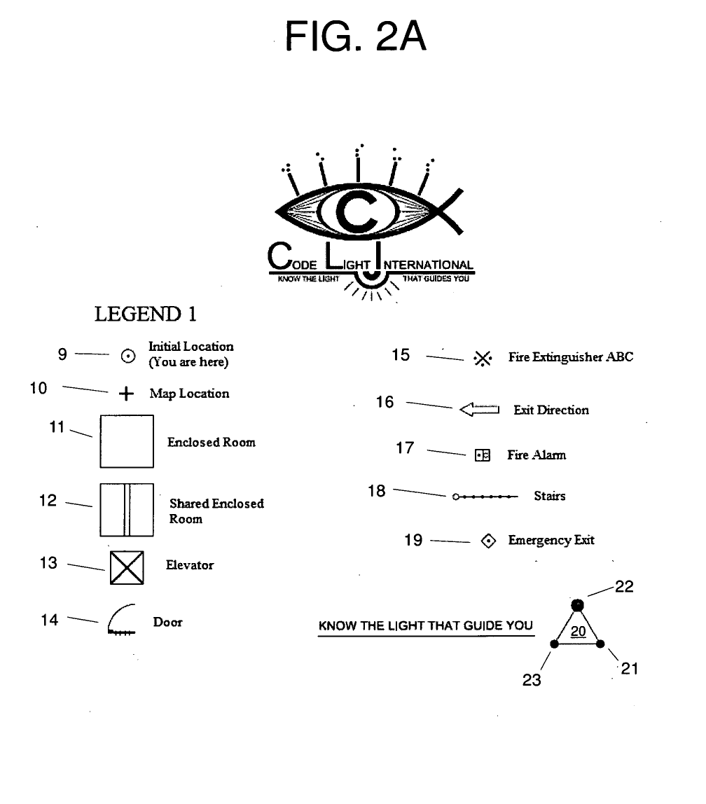

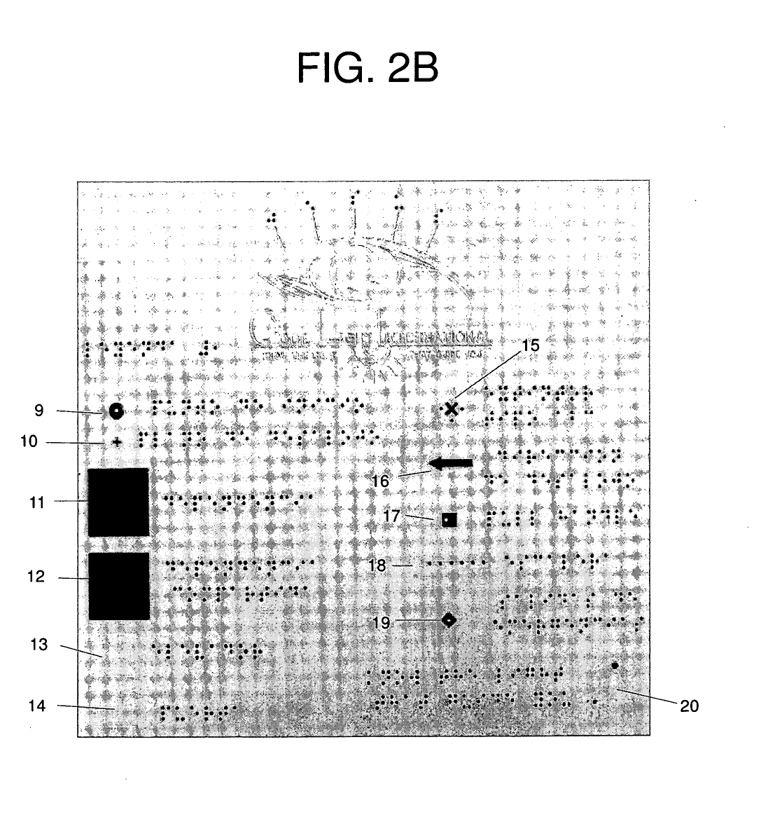

As will be explained below, the mobility map system of the invention comprises a multi-level hierarchy arrangement comprising a novel and efficient tactile indicating system embodied in a new set of universal symbols which will be explained in conjunction to FIGS. 2A-4B.

FIG. 2A shows a first set of symbols defined under Legend 1. Different legends are used for different levels according to the multi-level hierarchy arrangement of the present invention. Of course, it is envisioned that variations of the exemplary legends can be provided based on a particular area or structure. Symbol 9 represents the exact location of the individual interacting with a mobility map in relation to the area being represented and comprises of an embossed first circle positioned inside a smaller diameter circle. This symbol should always be positioned at the left side of the map. Symbol 10 represents the exact location of the mobility map in relation to the area represented and comprises an embossed cross-shaped element. Symbol 11 represents an enclosed room or office and comprises of an embossed large square. Symbol 12 represents a shared or divided enclosed room or office and comprises of an embossed polygon with an engraved line representing the division. Symbol 13 represents an elevator and comprises of an engraved 4-sided polygon with a cross-shaped element inside. Symbol 14 represents a door and comprises of an engraved semi-arc, a small square and a fine solid line including a plurality of transversal segments. The solid line represents a door; the small square represents a door lock and its exact location with respect to said door; the semi-arc represents the direction of door rotation and the transversal segments identify the door linear dimension, wherein each segment represents twelve inches. Symbol 15 represents an ABC-type fire extinguisher and comprises of an embossed “X”-shaped element defining a top, bottom, left and right area with three dots located inside the left, right and bottom areas. Symbol 16 represents directional elements comprising of an embossed arrow. Symbol 17 represents a fire alarm and comprises of an embossed four-sided polygon including an engraved dividing line separating the polygon into 2 sides, wherein one side comprises an embossed dot and the other side comprises a smaller engraved circle or dot. The smaller circle or dot further indicates the location of the alarm handle for activation purposes. Symbol 18 represents stairs comprising of an engraved circle and line and a plurality of embossed dots within the longitudinal direction of said line. The amount of dots represents the amount of stairs, wherein the engraved circle defines the beginning of said stairs and the line represents the geometry of said stairs. Symbol 19 represents an emergency exit or sign and comprises of an embossed diamond-shaped element with an engraved dot within. Symbol 20 is used as part of a multi-level hierarchy mobility system and comprises an engraved triangle with three embossed dots 21, 22 and 23, each positioned on a separate corner of the triangle. The size of the dots is selected to indicate a level within the multi-level hierarchy mobility system as will be explained in detail later. FIG. 2B shows an actual top view of the exemplified Legend 1 explained above.

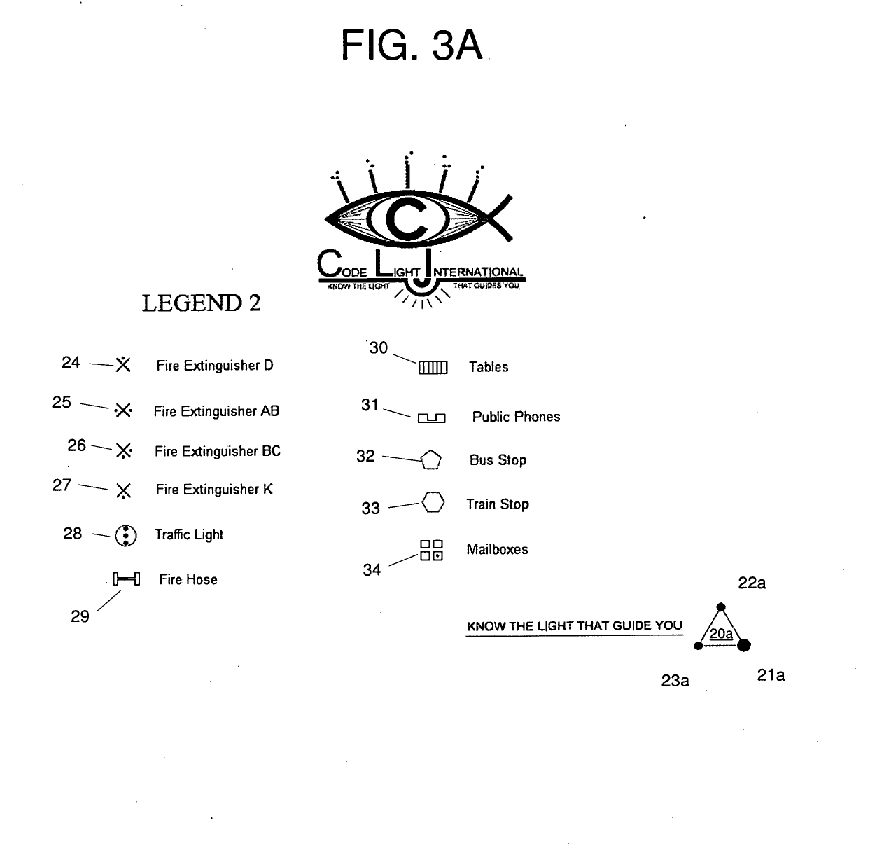

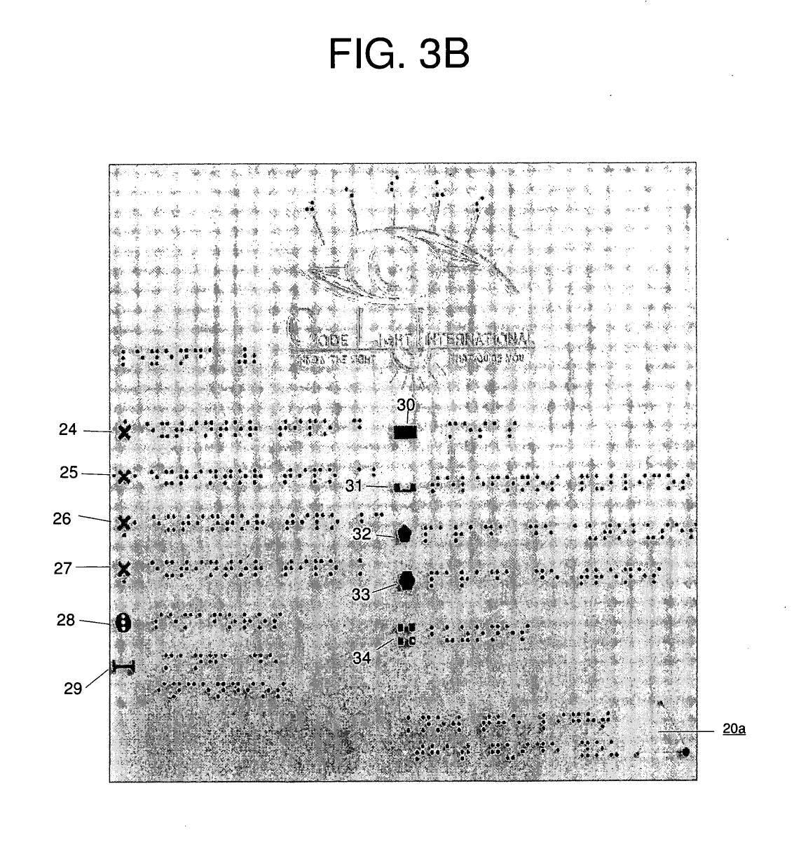

FIG. 3A shows a second set of symbols defined under Legend 2. Symbol 24 represents a D-type fire extinguisher and comprises of an embossed “X”-shaped element defining a top, bottom, left and right area with one dot located inside the top area. Symbol 25 represents an AB-type fire extinguisher and comprises of an embossed “X”-shaped element defining a top, bottom, left and right area with one dot located inside the left area and one dot located inside the right area. Symbol 26 represents a BC-type fire extinguisher and comprises of an embossed “X”-shaped element defining a top, bottom, left and right area with one dot located inside the bottom area and one dot located inside the right area. Symbol 27 represents a K-type fire extinguisher and comprises of an embossed “X”-shaped element defining a top, bottom, left and right area with one dot located inside the bottom. Symbol 28 represents a traffic light and comprises of an embossed circle containing three vertically-aligned embossed dots on top of said embossed circle. Symbol 29 represents a fire hose and comprises of an embossed “H”-shaped element, wherein the lateral lines are smaller in length than the central line of the “H” shape. Symbol 30 represents a table and comprises of an embossed rectangle having at least one engraved vertical line inside the rectangle. Each line defines the length of said table in linear feet. Symbol 31 is used to represent public phones and comprises of an embossed “U”-shaped element. Symbol 32 represents a bus stop and comprises of an embossed pentagon element. Symbol 33 represents a train stop and comprises of an embossed hexagonal element. Symbol 34 represents mailboxes and comprises of a plurality of contiguous embossed small squares, wherein one of the squares further comprises an embossed dot indicating the actual mailbox of the individual. Legend 2 also comprises a symbol 20a that is used as part of a multi-level hierarchy mobility system and comprises an engraved triangle with three embossed dots 21a, 22a and 23a, each positioned on a separate corner of the triangle. The size of the dots is selected to indicate a level within the multi-level hierarchy mobility system as will be explained in detail later. FIG. 3B shows an actual top view of the exemplified Legend 2 explained above.

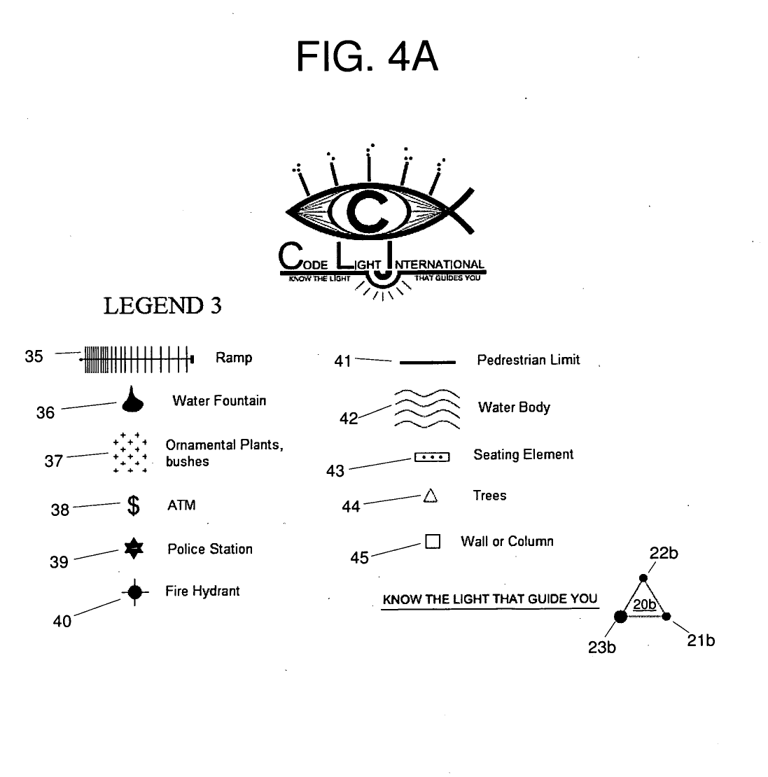

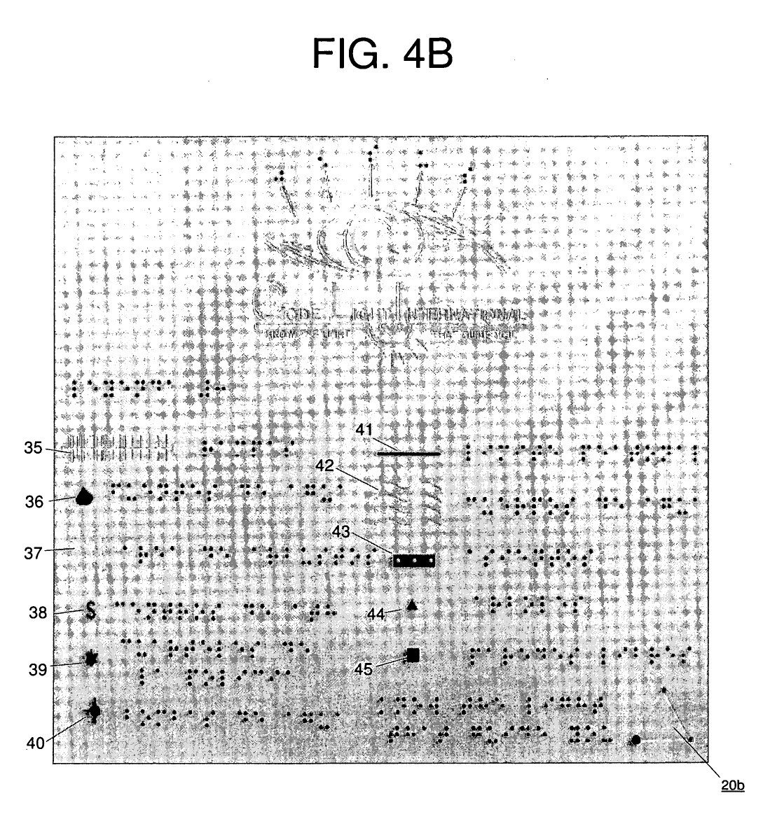

FIG. 4A shows a third set of symbols defined under Legend 3. Symbol 35 represents a ramp and comprises of an engraved horizontal line having an embossed dot at one end indicating the beginning of the ramp and an embossed small rectangle at the other end indicating the end of the ramp. The symbol also comprises a plurality of engraved transversal small lines positioned along the length of said horizontal line. The level of inclination of the ramp is defined by how close the transversal lines are positioned to each other (i.e., closer=more inclination; apart=less inclination). Symbol 36 represents a water fountain and comprises of an embossed water drop shaped element. Symbol 37 represents ornamental plants or bushes and comprises of a plurality of engraved small-sized crosses group together. Symbol 38 represents an ATM location and comprises of an embossed dollar sign “$” shaped element. Symbol 39 represents a police station and comprises of an embossed six-point star shaped element. Symbol 40 represents a fire hydrant location and comprises of an embossed circle having a plurality of lines extending outwardly from the periphery of said circle. Symbol 41 represents a pedestrian limit and comprises of an embossed line. Symbol 42 represents the location of a body of water and comprises a plurality of engraved curved lines. Symbol 43 represents a seating element and comprises of an embossed rectangle having a plurality of embossed dots representing the number of seat available. Symbol 44 represents trees or palms and comprises of an embossed triangle. Symbol 45 represents a visible wall or column and comprises of an embossed small square. Legend 3 also comprises a symbol 20b that is used as part of a multi-level hierarchy mobility system and comprises an engraved triangle with three embossed dots 21b, 22b and 23b, each positioned on a separate corner of the triangle. The size of the dots is selected to indicate a level within the multi-level hierarchy mobility system as will be explained in detail later. FIG. 4B shows an actual top view of the exemplified Legend 3 explained above.

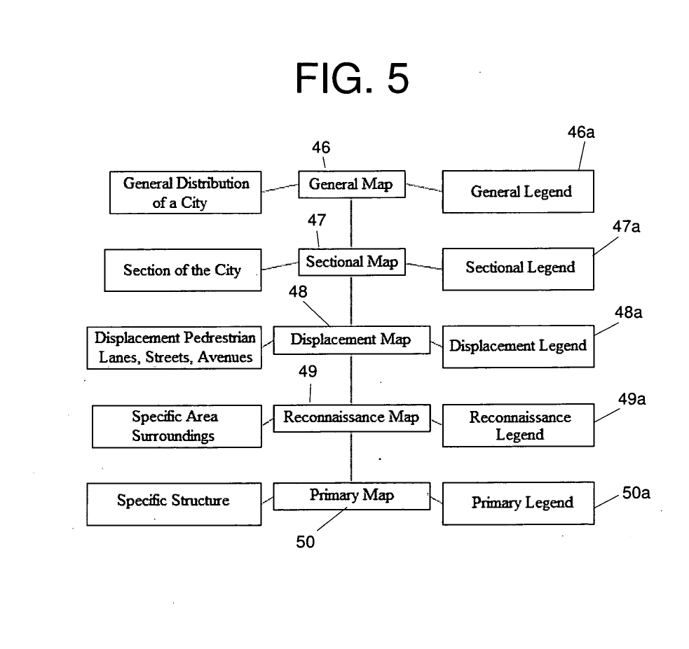

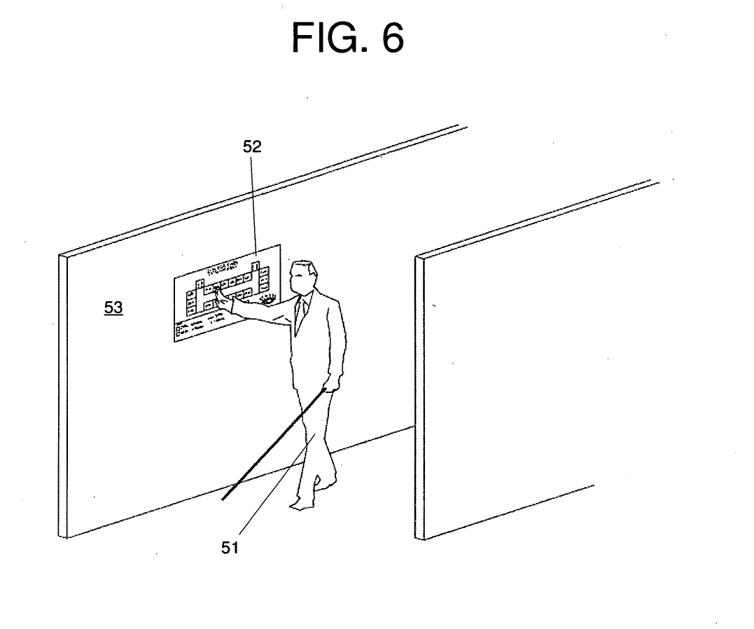

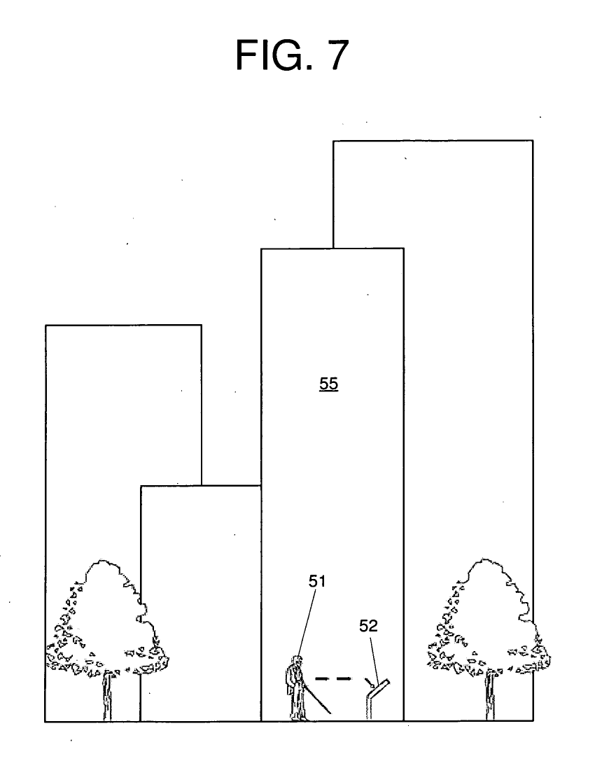

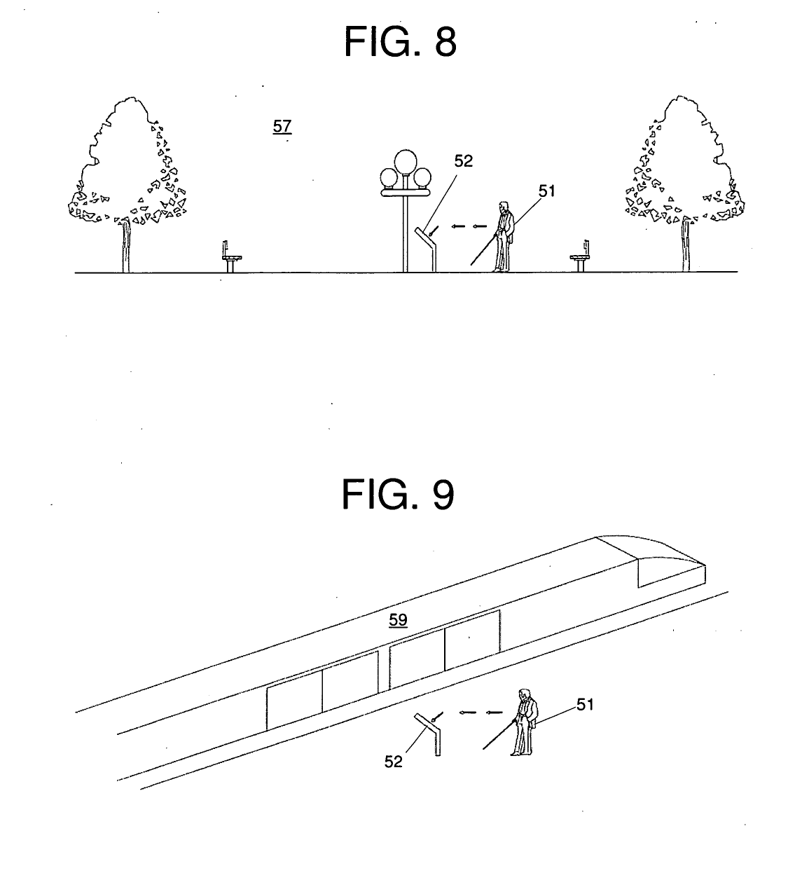

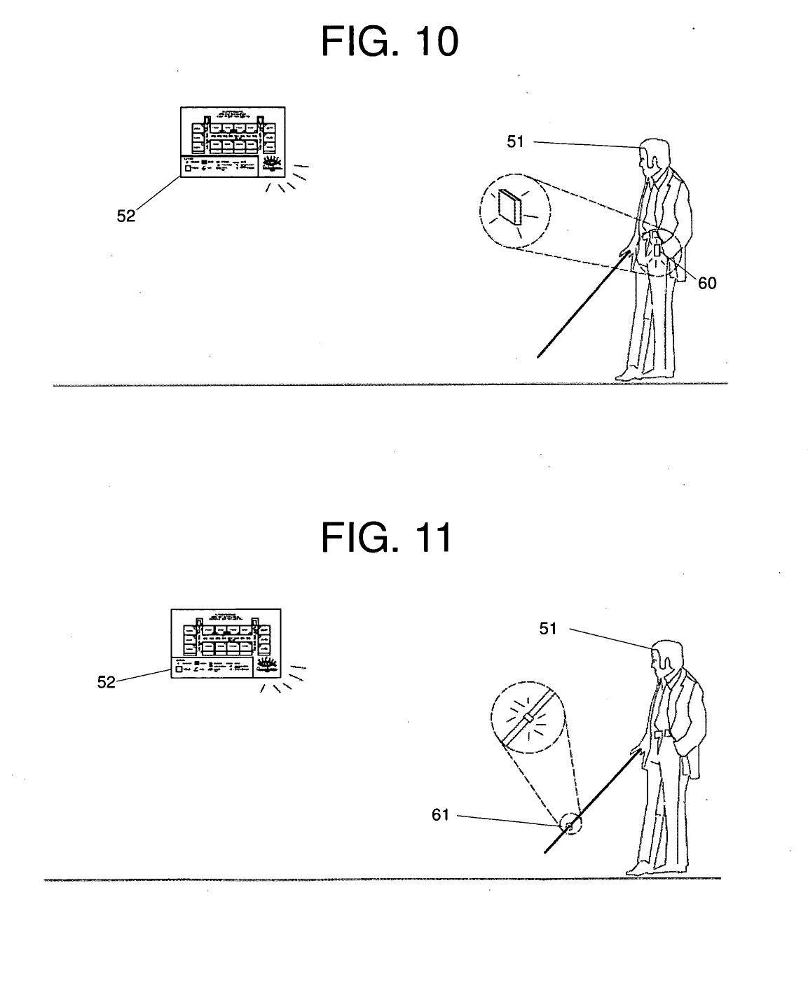

FIGS. 5-9 illustrate the multi-level hierarchy mobility system of the present invention. The inventor has devised a novel system that allows a visually-impaired individual to fully integrate into our society by providing a means for giving visually-impaired individuals a real sense of orientation in all levels and aspects of our daily routine. By using the inventive system, visually-impaired individuals will have the ability to move freely and relocate not only within a structure such as a building but also within many geographical levels such as states, cities, and neighborhoods without losing the structural and/or spatial relationship among the different levels. The system is implemented by integrating the symbols above-explained into the inventive mobility maps in order to provide a visually-impaired individual a continuous relationship among different levels within a region. A general map 46 will provide the necessary information to convey an individual the general spatial distribution of a geographical region such as a city. This map could be located for example at an airport so that when a visually-impaired individual arrives at a new city could have a general sense of the spatial distribution of the city. Once a visually-impaired individual arrives at a desired part or section of the city, a sectional map 47 will provide the visually-impaired individual 51 information regarding the structures, facilities, and parks among others 55, encountered within that section of the city as exemplified on FIG. 7 with map 52. In order to give visually-impaired individuals a real sense of displacement options a displacement map 48 is provided. This map 48 is selectively located to provide visually-impaired individuals 51 information such as pedestrian lanes, streets, avenues, bus and/or train stations/stops, etc 59, so that a visually-impaired individual selects how to relocate from one place to another as exemplified in FIG. 9 with map 52. Once a visually-impaired individual arrives at a desired area, a reconnaissance map 49 will provide the visually-impaired individual information regarding the surroundings of said area as exemplified in FIG. 8. Finally, when a visually-impaired individual 51 arrives at the desired location a primary map 50 provides specific information regarding the structure where the visually-impaired individual is located such as a building 53 as exemplified in FIG. 10 with a map 52. This primary map 50 is structure specific and could be provided either for an outdoor structure or an indoor structure. Thus, by strategically locating a plurality of these maps around and within a geographical region, visually-impaired individuals will gain accessibility and freedom to move and relocate since all the maps at any level provide spatial information that allows the integral operation among maps.

The operation of the mobility map system of the present invention is further enhanced by the utilization of indicating and translating means as exemplified in FIGS. 10-12. Specifically, an indicating means 60 and 61 could be used to indicate the visually-impaired individual the location of any mobility map. In preferred embodiment, a portable element 60 such as but not limited to a pager, could be worn by the visually-impaired individual so that when he/she is in proximity to a mobility map at least one visual and/or vibratory indication is provided so that the visually-impaired individual may locate and reach said map. Alternatively, an indicating means 61 could be located or integrated into an article such as but not limited to a cane as shown in FIG. 11. It is also envisioned, that a communication means could be provided within or combined with the mobility map of the invention that cooperates with indicating means 60 and 61 to direct the individual to the map dynamically and in real-time. For example, a control means could be integrated into the map to unidirectionally or bidirectionally communicate with indicating means 60 and 61. The information communicated between the map and the individual could be related to at least one of: directional instructions, emergency instructions, type of impairment, advertising, and personal. For example, when the control means determines based on the information provided by the indicating means 60 and 61, that the individual is also audibly-impaired, a vibratory indication could be used instead of, or in combination with an audible indication to direct the individual to the map. In another example, the individual could be provided with emergency-related information should there be one so that the individual could follow instructions or make an informed decision as to how to relocate. In a preferred embodiment, the communication between the mobility map and the indicating means 60 and 61 is implemented by a wireless means such as but not limited to: RF, IR, Bluetooth, Microwave, and WIFI.

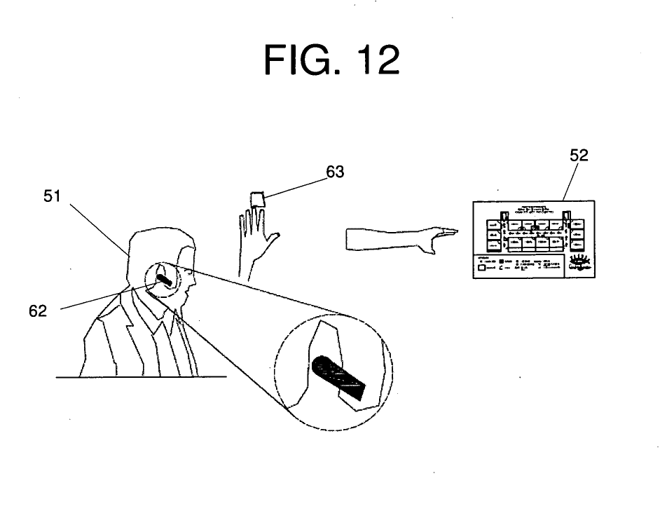

FIG. 12 illustrates how the present invention provides a means for allowing a visually-impaired individual that is not familiar with a specific blind-code such as but not limited to: Braille code to interact with the mobility map of the present invention. In the preferred embodiment, a user-wearable element 63 is selectively positioned in an individual hand so that when the individual's hand is in proximity or in contact with a specific portion of the map containing Braille code a translation of said code is provided to the individual. The element 63 comprises a reading means such as but not limited to a scanning means that reads the message encoded. In another embodiment, a message-specific means could be structurally positioned in the map portion having the specific Braille code so that when element 63 is in proximity with the message-specific means, specific information is transmitted. The information transmitted by said user-wearable element 63 is the received by another user-wearable element 62 in order to provide the visually-impaired individual an audible translation of the Braille code. In a preferred embodiment, communication between said user-wearable element 63 and said user-wearable element 62 is achieved by a wireless means such as but not limited to: RF, IR, Bluetooth, Microwave, and WIFI.

Because many varying and differing embodiments maybe made within the scope of the inventive concept herein taught and because many modifications may be made in the embodiment herein detailed in accordance with the descriptive requirement of the law, it is to be understood that the details herein are to be interpreted as illustrative and not in a limiting sense.

I claim:

1. A mobility map comprising:
a first element comprising a spatial representation of an area;
tactile indicia structurally related to said spatial representation of an area; and
information indicia conveying information to visually-impaired individuals.

2. The map of claim 1, further comprising a second element, wherein said first element is positioned over said second element.

3. The map of claim 2, wherein said second element comprises information indicia conveying information to visually-impaired people.

4. The map of claim 1, wherein said tactile indicia is selectively located on said first element.

5. The map of claim 2, wherein said tactile indicia is selectively located on said second element.

6. The map of claim 1, wherein said information indicia comprises blind or visually-impaired code.

7. The map of claim 3, wherein said information indicia comprises blind or visually-impaired code.

8. The map of claim 1, wherein said information indicia comprises directional indicia.

9. The map of claim 3, wherein said information indicia comprises directional indicia.

10. The map of claim 1, wherein said tactile indicia represents objects encountered by a person while moving through said area.

11. The map of claim 1, wherein said tactile indicia comprises at least one of: engraved elements and embossed elements.

12. The map of claim 1, wherein said tactile indicia comprises at least one of the following symbols:

| | |
|---|---|
| [symbol] = | Fire Extinguisher |
| | Type BC. |
| [symbol] = | Fire Extinguisher |
| | Type K. |
| [symbol] = | Emergency Sign. |
| [symbol] = | Traffic Light. |
| [symbol] = | Fire House. |
| [symbol] = | Table. |
| [symbol] = | Public phones. |
| [symbol] = | Bus stop. |
| [symbol] = | Train stop. |
| [symbol] = | Ramp. |
| [symbol] = | Mailboxes. |
| [symbol] = | Water fountain. |
| [symbol] = | Ornamental plants, |
| | bushes. |
| [symbol] = | ATM |
| [symbol] = | Police station. |
| [symbol] = | Fire hydrant. |
| [symbol] = | Water bodies |
| | (lakes, rivers). |
| [symbol] = | Alarm |
| [symbol] = | Map location. |
| [symbol] = | Elevator. |
| [symbol] = | Seating element. |
| [symbol] = | Trees. |
| [symbol] = | Wall or column. |
| [symbol] = | Shared enclosed |
| | room or area. |
| [symbol] = | Enclosed |
| | room or area. |
| [symbol] = | Door. |
| [symbol] = | Exit direction. |
| [symbol] = | Initial location |
| | (You are here). |
| [symbol] = | Pedestrian limit. |
| [symbol] = | Stairs. |
| [symbol] = | Fire Extinguisher |
| | Type ABC. |
| [symbol] = | Fire Extinguisher |
| | Type AB. |
| [symbol] = | Fire Extinguisher |
| | Type D. |

13. A multi-level mobility system comprising at least one mobility map of claim 1.

14. The multi-level mobility system of claim 13 comprising a general mobility map related to a geographical region.

15. The multi-level mobility system of claim 14 comprising a sectional mobility map related to a sub-region within said geographical region.

16. The multi-level mobility system of claim 15 comprising a traveling mobility map related to travel means within said sub-region.

17. The multi-level mobility system of claim 16 comprising a reconnaissance mobility map related to the area of interest.

18. The multi-level mobility system of claim 17 comprising a primary mobility map related to a specific structure within said area of interest.

19. The map of claim 1, further comprising a locating means indicating a person the location of said map.

20. The map of claim 1, further comprising translating means transforming said information indicia into audible indicia.
